(19) United States
(12) Patent Application Publication
(10) Pub. No.: US 2021/0335144 A1
(43) Pub. Date: Oct. 28, 2021

(54) COMPREHENSIVE SYSTEM AND METHODOLOGY BASED ON CROSS-DISCIPLINARY STUDIES OF COGNITIVE SCIENCE, LEARNING THEORIES AND PEDAGOGIES

(71) Applicant: HEADWAYINNOVATION,INC., New Rochelle, NY (US)

(72) Inventors: Alexander Sergeevich Yuryev Sergeevich Yuryev, (US); Valeriy Timofeevich SKUBEEV, Chita (RU)

(21) Appl. No.: 16/329,341

(22) PCT Filed: Jan. 13, 2019
(86) PCT No.: PCT/US19/13406

§ 371 Date: Feb. 28, 2019

(51) Int. Cl. G09B 7/04; G09B 19/00; G06Q 50/20

(52) U.S. Cl. CPC G09B 7/04; G06Q 50/205; G09B 19/00

(57) ABSTRACT

The present invention relates to system and method used by teachers to enable student learning of various disciplines and to gain skills. More particularly, the present invention is directed to systems and methods of teaching life skills and/or preparing individuals for life-type experiences. The system and method allow to measure and quantify information and knowledge and define skills by breaking them into smaller quantifiable and measurable units thereby creating minimal units of skills, next-gen skills. The system and method allow to adapt and use information in multiple contexts and scenarios after changing and modifying its corresponding restrictions thereby allowing to train learners to learn new skills or improve existing ones by training the adaptive information potential AIPs. The system and method provide comprehensive methodology that is based on the forefront cross-disciplinary studies of cognitive science, learning theories and pedagogies.

### FIELD OF THE INVENTION

The present invention relates to system and method used by teachers to enable student learning of various disciplines and to gain skills. More particularly, the present invention is directed to systems and methods of teaching life skills and/or preparing individuals for life-type experiences.

### BRIEF DESCRIPTION OF THE INVENTION

Typical, educational system includes the textbooks, the curricula, the classrooms, and the schedules students follow. This education system hasn't changed much over the centuries. To this day, the students receive mass-produced content that was designed around standardized tests. It is important to mention that these tests do not accommodate individual learning needs. The content has to be delivered in a very particular way, i.e. in a linear format. Let's say that the entire education path presents a plurality of Units, i.e. Unit 1, Unit 2, and so on, whereby the students are not supposed to proceed to Unit 2 until they learned Unit 1. Nor will the students will understand Unit 3 until the students have learned Unit 2, and so on.

Another approach of education is called a non-linear learning. On one level, non-linear learning is the way that people naturally learned for a couple of hundred thousand years. For example, people didn't learn to fish or hunt in a linear way—through a staggered, textbook process. Instead, people learned to do these tasks by doing, through direct experience and dealing with things as they arose. People also learned how to fish or hunt or other skills through discovering what was important at that particular time and through making connections between stuff people already knew and didn't know by actively constructed the knowledge as people needed it. It was all very subjective and individual and not linear.

Alluding to the above, human brains are designed to work/learn this way, but it is a subjective process because each individual experience distinct social and psychological phenomenon. As is was perfectly presented by some scholars “It is not an objective one size fit, but an experience that is entirely unique . . . learning in the natural environment was not linear. There is a level on which it was actually quite random. It was situational”.

Today, life skills, such as career and retirement planning, are often not in the curriculum of formal educational institutions. However, it is particularly important to teach such skills to teenagers who have not yet started their careers, and adults who have started their careers, but face many obstacles and decisions that have to be made regarding their career paths and retirement plans. Further, many individuals, once they begin their careers, are not prepared for the experiences they will encounter along the way, such as experiences with supervisors, also known as bosses.

A teaching method comprises the principles and methods used by teachers to enable student learning. These strategies are determined partly on subject matter to be taught and partly by the nature of the learner. For a particular teaching method to be appropriate and efficient it has to be in relation with the characteristic of the learner and the type of learning it is supposed to bring about. Suggestions are there to design and selection of teaching methods must take into account not only the nature of the subject matter but also how students learn. In today's school the trend is that it encourages a lot of creativity. It is a known fact that human advancement comes through reasoning. This reasoning and original thought enhances creativity.

The approaches for teaching can be broadly classified into teacher centered and student centered. In teacher-centered approach to learning, teachers are the main authority figure in this model. Students are viewed as “empty vessels” whose primary role is to passively receive information (via lectures and direct instruction) with an end goal of testing and assessment. It is the primary role of teachers to pass knowledge and information onto their students. In this model, teaching and assessment are viewed as two separate entities. Student learning is measured through objectively scored tests and assessments.

In student-centered approach to learning, while teachers are the authority figure in this model, teachers and students play an equally active role in the learning process. The teacher's primary role is to coach and facilitate student learning and overall comprehension of material. Student learning is measured through both formal and informal forms of assessment, including group projects, student portfolios, and class participation. Teaching and assessments are connected; student learning is continuously measured during teacher instruction. Commonly used teaching methods may include class participation, demonstration, recitation, memorization, or combinations of these.

Referring now to an adaptive learning, it is important to say that it is a sophisticated, data-driven, and in some cases, nonlinear approach to instruction and remediation, adjusting to a learner's interactions and demonstrated performance level, and subsequently anticipating what types of content and resources learners need at a specific point in time to make progress.

Adaptive learning has the potential to transform student learning by providing students with self-paced individualized learning experiences. Adaptive learning can be defined as an approach to creating a personalized learning experience for students. Adaptive learning also takes a sophisticated, data-driven, and in some cases, non-linear approach to instruction and remediation, adjusting to a learner's interactions and demonstrated performance level and subsequently anticipating what types of content and resources learners need at a specific point in time to make progress.

Alluding to the above, active learning occurs when students are no longer just passive participants in the learning process. Active learning can be as simple as students working in groups in the classroom instead of listening to a lecture.

The combination of adaptive and active has been shown to increase student outcomes. These pedagogical approaches provide faculty with data and insight about student performance. As a result, more faculty are changing the tactics they use in the classroom to be active and make sure all students succeed or achieve mastery sooner.

However, prior art systems and methods of teaching have several negatives or drawbacks. All attempts to define skills and what constitutes skills have failed to bring a unified and comprehensive definition or structure of skills in the sense that it applies to all contexts, types of skills, levels, and the like. The current available solutions and methods try to package information and content against “skills” however they vary in size, content size, information covered, etc.

Thus, a particular course in higher education context to teach a skill will vary from one university to another, also it will be different to any of those same “skill” courses offered via trainers, or online training websites.

To the extent as being effective, there is always a need for new and improved systems and methods directed to systems and methods of teaching life skills and/or preparing individuals for life-type experiences. The present invention aims to solve this problem by simple and convenient means.

### SUMMARY OF THE INVENTION

A method of teaching a person to learn various disciplines and to gain skills based on cross-disciplinary studies of cognitive science, learning theories, and pedagogies, includes the step of forming a group including at least two subject area sections grouped by a topic and/or theme. Then, each of the at least two subject area sections is separated into sub-levels that reflect a skill element such as specification and specialization of the respective subject area. The method further includes the step of generating a plurality of scenarios including series or logical chains of learning blocks fitting according to how the person learns while checking cognigraphic profile of the person in order to adapt to any change to different level or scenario to allow to measure and quantify information and knowledge and define skills by breaking them into smaller quantifiable and measurable units thereby creating minimal units of skills.

The method further includes the step of determining if the skill is learned in response comprehensive questions and tests from different scenarios and levels thereby evaluating whether the person who was exposed to information in multiple contexts and scenarios after changing and modifying its corresponding restrictions thereby allowing to train learners to learn new skills or improve existing ones by training the adaptive information potential.

In a second alternative embodiment of the present invention, the method for teaching at least one skill to a learner or a student begins with forming a group including multiple subject areas or area sections grouped by a topic and/or theme including and not limited to Finance, Business, Psychology, Law, Economics, Performance Arts, Visual Arts, Education, Journalism, Medicine, Public Administration, Engineering, Computer Science, Mathematics, Sciences, Sociology, Accounting. The topics and themes listed above are not intended to limit the scope of the present invention.

For proper tracking purposes, a plurality of first identifiers, such as, for example, A1, A2, A3, A4, . . . An, are assigned to each subject area section topically designed and established to separate specific concentrations and areas of study within the group as per the theme or the topic of study, and the function. Then, method separates each of the at least two subject area sections into sub-levels that reflect a skill element such as specification and specialization of the respective subject area.

A plurality of second identifiers, such as, for example, B1, B 2, B 3, B 4, . . . Bn, are assigned to each skill element wherein each skill element represents the ability to adequately perform, execute, and apply a specific number of potentials that can be functionally, topically or thematically linked and grouped together.

A plurality of third identifiers such as, for example, C1, C2, C 3, C 4, . . . Cn are assigned to each of the skill element wherein each of the third identifiers C1, C2, C 3, C 4, Cn, indicates at least one of the respective skill level, type, and category.

The method also requires a list of criterial elements correlated to list of skill demands, wherein each of the criterial elements is assigned a plurality of fourth identifiers, such as, for example, D1, D2, D3, D4, . . . Dn. The method allows to determine Adaptive Information Potential (AIP) of each learner by performing a single action to adapt information in multiple contexts and scenarios after changing and modifying its corresponding restrictions such as “can perform” and “can't perform”.

A plurality of scenarios including series or logical chains of learning blocks will be checked to make sure that they are fitting exactly according to how the learner or the student learns while checking cognigraphic profile of the learner in order to adapt to any change and redirect them to different levels or scenarios.

The method further will determine and track relationship and correlation between the plurality of the first identifiers A1, A2, A3, A4, . . . An, the second identifiers B1, B 2, B 3, B 4, . . . Bn, the third C1, C2, C 3, C 4, . . . Cn in order to relate the final result to match with the plurality of fourth identifiers D1, D2, D3, D4, . . . Dn if the skill is learned in response comprehensive questions and tests from different scenarios and levels thereby evaluating whether the learner has successfully completed the scenarios and completed the training.

An advantage of the present invention is to provide innovative system and method that will allow to measure and quantify information and knowledge and define skills by breaking them into smaller quantifiable and measurable units thereby creating minimal units of skills, next-gen skills.

Another advantage of the present invention is to provide the innovative system and method that will allow to adapt and use information in multiple contexts and scenarios after changing and modifying its corresponding restrictions.

Still another advantage of the present invention is to provide the innovative system and method that will allow actions and skills to be practiced and challenged through scenarios ability to assess learners through AIP assessment.

Still another advantage of the present invention is to provide the innovative system and method that will allow to train learners to learn new skills or improve existing ones by training those AIPs.

Still another advantage of the present invention is to provide the innovative system and method that will provide comprehensive methodology based on the forefront cross-disciplinary studies of cognitive science, learning theories and pedagogies.

Still another advantage of the present invention is to provide the innovative system and method improving learners' cognitive abilities through training in different cognitive levels.

Still another advantage of the present invention is to provide the innovative system and method that presents adapting courses to learners' cognitive profile, abilities, and other non-cognitive factors.

Still another advantage of the present invention is to provide the innovative system and method presenting a variety of courses to show balance between depth and breadth of courses and information presented.

Still another advantage of the present invention is to provide the innovative system and method that will allow speeding up and systematizing knowledge acquisition and information management in organizations.

The objects and advantages of the present invention will be more readily apparent from inspection of the following specification, taken in connection with the accompanying drawing, wherein like numerals refer to like parts throughout and in which an embodiment of the present invention is described and illustrated.

The exact manner in which the foregoing and other objects and advantages of the invention are achieved in practice will become more clearly apparent when reference is made to the following detailed description of the preferred embodiments of the invention described in detail in the following specification and shown in the accompanying drawings, where in like reference numbers indicate corresponding parts throughout.

### BRIEF DESCRIPTION OF THE DRAWINGS

Other advantages of the present invention will be readily appreciated as the same becomes better understood by reference to the following detailed description when considered in connection with the accompanying drawings wherein:

FIGS. 1 through 3 illustrate various schematic views of a method for teaching a person to learn various disciplines and to gain skills based on cross-disciplinary studies of cognitive science, learning theories, and pedagogies, includes the step of forming a group including at least two subject area sections grouped by a topic and/or theme.

### DETAILED DESCRIPTION OF THE INVENTION

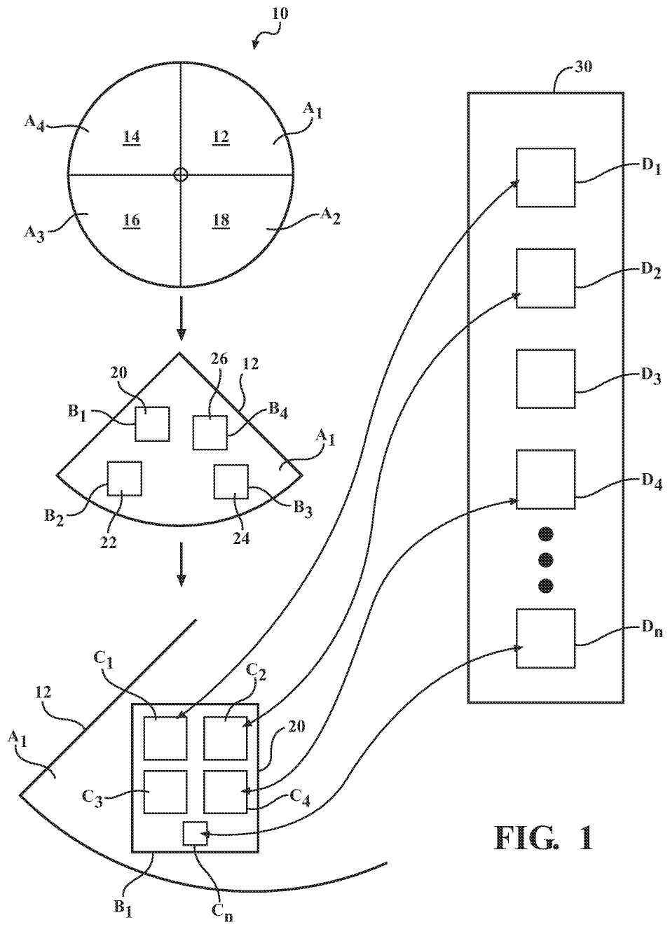

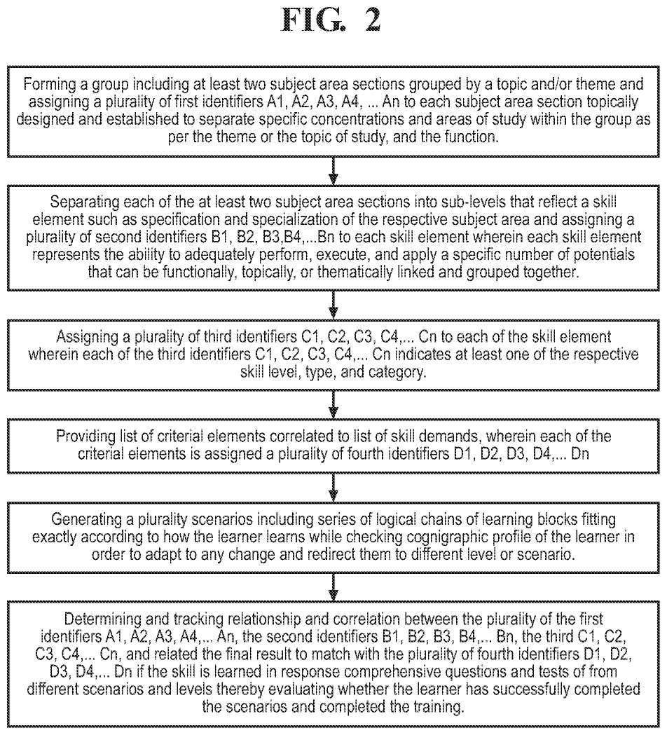

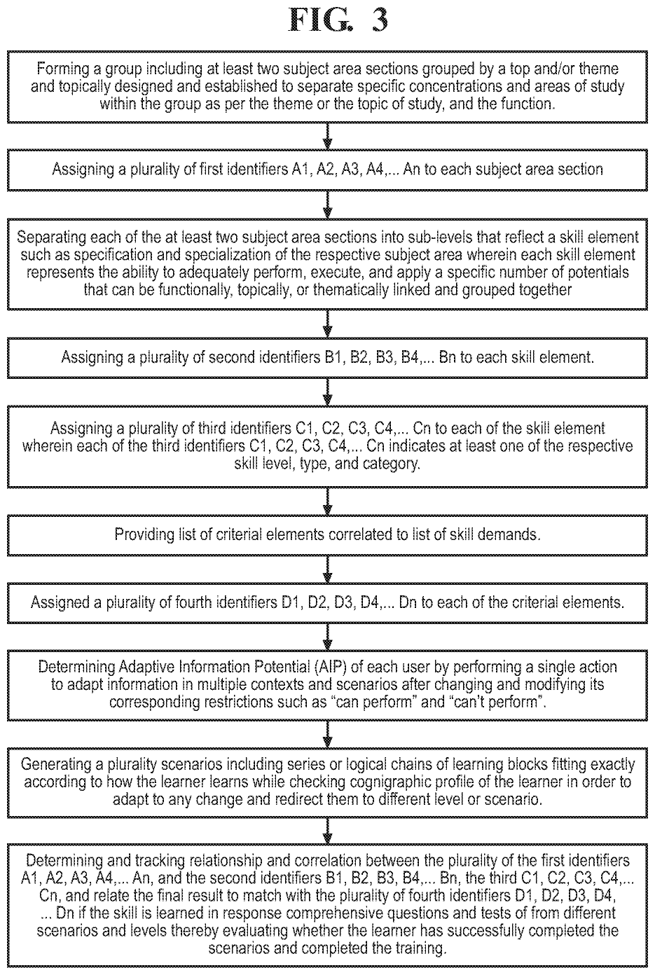

Referring to the FIG. 1, wherein like numerals indicate like or corresponding parts, a method for teaching at least one skill to a learner, i.e. student, is generally shown at 10 in FIGS. 1, 100 and 200 in FIGS. 2 and 3. FIG. 1 shows various components required to implement the method 10. One of the components of the method 10 includes a group of multiple subject areas or area sections, shown at 12, 14, 16, and 18, grouped by a topic and/or theme including and not limited to Finance, Business, Psychology, Law, Economics, Performance Arts, Visual Arts, Education, Journalism, Medicine, Public Administration, Engineering, Computer Science, Mathematics, Sciences, Sociology, Accounting.

These areas are also called Domains, which comprise one subject area or related subject areas grouped by a topic or a theme. Departments are second level specialization of the domain. Departments are meant to be topically designed and established to separate specific concentrations and areas of study within the same domain as per the theme or the topic of study, or even the function. For example, Business domain has many departments including Marketing. Alluding to the above, the topics and themes listed above are not intended to limit the scope of the present invention.

For proper tracking purposes a plurality of first identifiers A1, A2, A3, A4, . . . An are assigned to each subject area section or domain 12, 14, 16, and 18 topically designed and established to separate specific concentrations and areas of study within the group as per the theme or the topic of study, and the function. Each of the subject area sections 12, 14, 16, and 18 is divided into respective sub-levels, wherein each reflects a skill element 20, 22, 24, 26 such as specification and specialization of the respective subject area.

A plurality of second identifiers such as B1, B 2, B 3, B 4, . . . Bn are assigned to each skill element 20, 22, 24, 26, wherein each skill element 20, 22, 24, 26 represents the ability to adequately perform, execute, and apply a specific number of potentials that can be functionally, topically or thematically linked and grouped together. Each sub-level, such as sub-level 20, as shown in FIG. 1, reflects multiple skill elements.

A plurality of third identifiers C1, C2, C 3, C 4, . . . Cn are assigned to each of the skill element 20, wherein each of the third identifiers C1, C2, C 3, C 4, . . . Cn indicates at least one of the respective skill level, type, and category. A list of criterial elements 30 correlated to list of skill demands, is separated by a plurality of fourth identifiers D1, D2, D3, D4, . . . Dn.

A plurality of scenarios including series or logical chains of learning blocks will be checked to make sure that they are fitting exactly according to how the learner learns while checking cognigraphic profile of the learner in order to adapt to any change and redirect them to different level or scenario. The method allows to determine and track relationship and correlation between the plurality of the first identifiers A1, A2, A3, A4, . . . An, the second identifiers B1, B 2, B 3, B 4, . . . Bn, the third C1, C2, C 3, C 4, . . . Cn in order to relate the final result to match with the plurality of fourth identifiers D1, D2, D3, D4, . . . Dn if the skill is learned in response comprehensive questions and tests of from different scenarios and levels thereby evaluating whether the learner has successfully completed the scenarios and completed the training.

The method 10 allows to determine Adaptive Information Potential (AIP) of each learner by performing a single action to adapt information in multiple contexts and scenarios after changing and modifying its corresponding restrictions such as “can perform” and “can't perform”.

Alluding to the above, the departments then are broken down to sub-levels that reflect more specification and specialization of the study areas until we reach the skill level. For Example, Marketing department is broken to different sub-levels and one of them is the following: Business>Marketing>Strategic Planning>Strategic Analysis Method. Skill: is the last sub-level before AIPs. Any skill is the ability to adequately perform, execute, and apply a specific number of potentials (AIPs) that can be functionally, topically or thematically linked and grouped together.

A skill must include a [verb+ing] (Gerund) to indicate the skill level, type, and category. For example, the previous categorization and division of domain and sub-levels: Business>Marketing>Strategic Planning>Strategic Analysis Method, the last sub-level consists of many skills including “Analyzing Demands”. AIP: single action ability to adapt information in multiple contexts and scenarios after changing and modifying its corresponding restrictions that must have only two options: “can do”, or, “cannot do”, with no gradable performance measurement. Many AIPs comprise and make a skill.

In the previous example, “Analyzing Demands” can consist of many AIPs including: 1) Identify demands; 2) Sort demands; 3) Rank demands; 4) Link demand to factor; etc. Referring to the aforementioned scenarios: each AIP consists of limitless number of scenarios. Scenarios are series or logical chains of learning blocks fitting exactly according to how the learner learns that connect input blocks and output blocks together while constantly checking cognigraphic profile of learner in order to adapt to any change and redirect them to different level or scenario.

Alluding to the above, the AIPs must be modified, replicated and distributed in cognitive levels. These levels are either a cognitive ability or trait or capacity or intelligence type. All scenarios and content in each level is modified to fit the type of level in order to promote and enhance that particular cognitive ability or trait or capacity or intelligence type.

The learners are assessed against AIPs. There are two types of assessment are of two types: AIP ability assessment: it assesses the learners' ability to perform or execute the AIP. It has two only options. Can perform/do/execute the potential/action of the AIP or not. AIP Full Assessment: it includes a comprehensive questions and tests of the AIP from different scenarios and level to evaluate and judge whether the learner has successfully completed the scenarios and the AIP training in order to consider this AIP complete.

Referring to FIG. 2, the method 100 starts with the step 102 of forming a group including at least two subject area sections grouped by a topic and/or theme and assigning a plurality of first identifiers A1, A2, A3, A4, . . . An to each subject area section topically designed and established to separate specific concentrations and areas of study within the group as per the theme or the topic of study, and the function.

Next step is the step of separating 104 each of the at least two subject area sections into sub-levels that reflect a skill element such as specification and specialization of the respective subject area and assigning a plurality of second identifiers B1, B 2, B 3, B 4, . . . Bn to each skill element wherein each skill element represents the ability to adequately perform, execute, and apply a specific number of potentials that can be functionally, topically or thematically linked and grouped together.

The method 100 further proceeds to the step 106 of assigning a plurality of third identifiers C1, C2, C 3, C 4, . . . Cn to each of the skill element wherein each of the third identifiers C1, C2, C 3, C 4, . . . Cn indicates at least one of the respective skill level, type, and category.

Alluding to the above, the method 100 further includes the step of providing 108 the list of criterial elements correlated to list of skill demands, wherein each of the criterial elements is assigned a plurality of fourth identifiers D1, D2, D3, D4, . . . Dn. This step may also proceed to the step of determining Adaptive Information Potential (AIP) of each user by performing a single action to adapt information in multiple contexts and scenarios after changing and modifying its corresponding restrictions such as “can perform” and “can't perform”.

The method 100 further includes the step of generating 110 a plurality scenarios including series or logical chains of learning blocks fitting exactly according to how the learner learns while checking cognigraphic profile of the learner in order to adapt to any change and redirect them to different level or scenario. The method 100 further includes the step of determining 112 and tracking relationship and correlation between the plurality of the first identifiers A1, A2, A3, A4, . . . An, the second identifiers B1, B 2, B 3, B 4, . . . Bn, the third C1, C2, C 3, C 4, . . . Cn, and relate the final result to match with the plurality of fourth identifiers D1, D2, D3, D4, . . . Dn if the skill is learned in response comprehensive questions and tests of from different scenarios and levels thereby evaluating whether the learner has successfully completed the scenarios and completed the training.

The method 200 starts with the step 202 of forming a group including at least two subject area sections grouped by a topic and/or theme and topically designed and established to separate specific concentrations and areas of study within the group as per the theme or the topic of study, and the function.

The next step is assigning 204 a plurality of first identifiers A1, A2, A3, A4, . . . An to each subject area section followed by separating 206 each of the at least two subject area sections into sub-levels that reflect a skill element such as specification and specialization of the respective subject area wherein each skill element represents the ability to adequately perform, execute, and apply a specific number of potentials that can be functionally, topically or thematically linked and grouped together.

Alluding to the above, the method 200 proceeds to the step of assigning 208 a plurality of second identifiers B1, B 2, B 3, B 4, . . . Bn to each skill element and assigning 210 a plurality of third identifiers C1, C2, C 3, C 4, . . . Cn to each of the skill element wherein each of the third identifiers C1, C2, C 3, C 4, . . . Cn indicates at least one of the respective skill level, type, and category.

The method 200 further includes the step of providing 212 list of criterial elements correlated to list of skill demands followed by assigning 214 a plurality of fourth identifiers D1, D2, D3, D4, . . . Dn to each of the criterial elements. The method 200 includes the step of determining 216 Adaptive Information Potential (AIP) of each user by performing a single action to adapt information in multiple contexts and scenarios after changing and modifying its corresponding restrictions such as “can perform” and “can't perform”.

The next step of the method 200 is the step of generating 218 a plurality scenario including series or logical chains of learning blocks fitting exactly according to how the learner learns while checking cognigraphic profile of the learner in order to adapt to any change and redirect them to different level or scenario.

The next step of the method 200 is the step of determining 220 and tracking relationship and correlation between the plurality of the first identifiers A1, A2, A3, A4, . . . An, the second identifiers B1, B 2, B 3, B 4, . . . Bn, the third C1, C2, C 3, C 4, . . . Cn, and relate the final result to match with the plurality of fourth identifiers D1, D2, D3, D4, . . . Dn if the skill is learned in response comprehensive questions and tests of from different scenarios and levels thereby evaluating whether the learner has successfully completed the scenarios and completed the training.

It will be apparent that multiple embodiments of this disclosure may be practiced without some or all of these specific details. In other instances, well-known process operations have not been described in detail in order not to unnecessarily obscure the present embodiments. The following description of embodiments includes references to the accompanying drawing. The drawing shows illustrations in accordance with example embodiments. These example embodiments, which are also referred to herein as “examples,” are described in enough detail to enable those skilled in the art to practice the present subject matter.

The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

Alluding to the above, for purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof.

Therefore, it is intended that the invention not be limited to the particular embodiment disclosed as the best mode contemplated for carrying out this invention, but that the invention will include all embodiments falling within the scope of the appended claims.

1. A method of teaching a learner, said method comprising the steps of:
forming a group including at least two subject area sections grouped by a topic and/or a theme;
separating each of the at least two subject area sections into sub-levels wherein each of the sub-levels reflect a skill element such as specification and specialization of respective subject area wherein each skill element represents the ability to adequately perform, execute, and apply a specific number of potentials of the learner that can be functionally, topically or thematically linked and grouped together;
providing a list of criterial elements correlated to a list of skill demands;
determining Adaptive Information Potential (AIP) of each learner by performing a single action to adapt information in multiple contexts and scenarios after changing and modifying its corresponding restrictions such as “can perform” and “can't perform”;
generating a plurality of scenarios including series and logical chains of learning blocks fitting according to how the learner learns while checking cognigraphic profile of the learner in order to adapt to any change and redirect them to different levels or scenarios; and
determining if the learner learned the skill in response comprehensive questions and tests of from different scenarios and levels thereby evaluating whether the learner has successfully completed the scenarios and completed the training.

2. The method as set forth in claim 1, including the step of assigning a plurality of first identifiers A1, A2, A3, A4, . . . An to each subject area section topically designed and established to separate specific concentrations and areas of study within the group as per the theme or the topic of study, and the function.

3. The method as set forth in claim 1, including the step of assigning a plurality of second identifiers B1, B 2, B 3, B 4, . . . Bn to each skill element.

4. The method as set forth in claim 1, including the step of assigning a plurality of third identifiers C1, C2, C 3, C 4, . . . Cn to each of the skill element wherein each of the third identifiers C1, C2, C 3, C 4, . . . Cn indicates at least one of the respective skill level, type, and category.

5. The method as set forth in claim 1, including the step of providing list of criterial elements correlated to list of skill demands, wherein each of the criterial elements is assigned a plurality of fourth identifiers D1, D2, D3, D4, . . . Dn.

6. The method as set forth in claim 1, including the step of determining and tracking relationship and correlation between the plurality of the first identifiers A1, A2, A3, A4, . . . An, the second identifiers B1, B 2, B 3, B 4, . . . Bn, the third C1, C2, C 3, C 4, . . . Cn, and relate the final result to match with the plurality of fourth identifiers D1, D2, D3, D4, . . . Dn.

7. A method of teaching a learner, said method comprising the steps of:
forming a group including at least two subject area sections grouped by a topic and/or a theme and assigning a plurality of first identifiers A1, A2, A3, A4, . . . An to each subject area section topically designed and established to separate specific concentrations and areas of study within the group as per the theme or the topic of study, and the function;
separating each of the at least two subject area sections into sub-levels that reflect a skill element such as specification and specialization of the respective subject area and assigning a plurality of second identifiers B1, B 2, B 3, B 4, . . . Bn to each skill element wherein each skill element represents the ability to adequately perform, execute, and apply a specific number of potentials that can be functionally, topically or thematically linked and grouped together;
assigning a plurality of third identifiers C1, C2, C 3, C 4, . . . Cn to each of the skill element wherein each of the third identifiers C1, C2, C 3, C 4, . . . Cn indicates at least one of the respective skill level, type, and category;
providing a list of criterial elements correlated to a list of skill demands, wherein each of the criterial elements is assigned a plurality of fourth identifiers D1, D2, D3, D4, . . . Dn; and
determining Adaptive Information Potential (AIP) of each learner by performing a single action to adapt information in multiple contexts and scenarios after changing and modifying its corresponding restrictions such as “can perform” and “can't perform”;
generating a plurality of scenarios including series or logical chains of learning blocks fitting exactly according to how the learner learns while checking cognigraphic profile of the learner in order to adapt to any change and redirect the learner to different levels and scenarios; and
determining and tracking relationship and correlation between the plurality of the first identifiers A1, A2, A3, A4, . . . An, the second identifiers B1, B 2, B 3, B 4, . . . Bn, the third C1, C2, C 3, C 4, . . . Cn, and relate the final result to match with the plurality of fourth identifiers D1, D2, D3, D4, . . . Dn if the skill is learned in response comprehensive questions and tests of from different scenarios and levels thereby evaluating whether the learner has successfully completed the scenarios and completed the training.

8. The method for teaching a learner, as set forth in claim 7, wherein the step of forming the group including at least two subject area sections grouped by a topic and/or theme is further defined by topics of Finance, Business, Psychology, Law, Economics, Performance Arts, Visual Arts, Education, Journalism, Medicine, Public Administration, Engineering, Computer Science, Mathematics, Sciences, Sociology, Accounting.

9. A method for teaching a person to learn various disciplines and to gain skills based on cross-disciplinary studies of cognitive science, learning theories, and pedagogies, the method comprising the steps of:
forming a group including at least two subject area sections grouped by a topic and/or theme;
separating each of the at least two subject area sections into sub-levels that reflect a skill element such as specification and specialization of the respective subject area wherein each skill element;
generating a plurality of scenarios including series or logical chains of learning blocks fitting according to how the person learns while checking cognigraphic profile of the person in order to adapt to any change to different level or scenario to allow to measure and quantify information and knowledge and define skills by breaking them into smaller quantifiable and measurable units thereby creating minimal units of skills, next-gen skills; and
determining if the skill is learned in response comprehensive questions and tests of from different scenarios and levels thereby evaluating whether the person who was exposed to information in multiple contexts and scenarios after changing and modifying its corresponding restrictions thereby allowing to train the person to learn new skills or improve existing ones by training the adaptive information potential of the person.
